(19) United States
(12) Patent Application Publication
(10) Pub. No.: US 2014/0182567 A1
(43) Pub. Date: Jul. 3, 2014

(54) EXHAUST GAS RECIRCULATION VALVE DEVICE FOR VEHICLE

(71) Applicants: Kia Motors Corporation, Seoul (KR); Hyundai Motor Company, Seoul (KR)

(72) Inventors: Jaepil LIM, Hwaseong-si (KR); Chan Seok JEONG, Seoul (KR); Suk-Il PARK, Hwaseong-si (KR); Deok Jae LEE, Hwaseong-si (KR)

(73) Assignees: Kia Motors Corporation, Seoul (KR); Hyundai Motor Company, Seoul (KR)

(21) Appl. No.: 14/081,613

(22) Filed: Nov. 15, 2013

(30) Foreign Application Priority Data
Dec. 27, 2012 (KR) 10-2012-0155360

(51) Int. Cl. F02M 25/07

(52) U.S. Cl. CPC F02M 25/0787
USPC 123/568.12; 123/568.11

(57) ABSTRACT

An exhaust gas recirculation valve device for a vehicle includes a valve housing having an exhaust gas inlet port and an exhaust gas outlet port, a flap valve rotatably mounted on the valve housing to open and close the exhaust gas outlet port, and a valve shaft fitted to penetrate the flap valve and coupled to the flap valve by electron beam welding to rotate integrally with the flap valve.

### CROSS-REFERENCE TO RELATED APPLICATION

The present application claims priority of Korean Patent Application Number 10-2012-0155360 filed Dec. 27, 2012, the entire contents of which application are incorporated herein for all purposes by this reference.

### BACKGROUND OF INVENTION

1. Field of Invention

The present invention relates to an exhaust gas recirculation (EGR) valve device for a vehicle, and more particularly, to an exhaust gas recirculation valve device for a vehicle in which a valve shift, a lever, and a flap valve are coupled together by electron beam welding.

2. Description of Related Art

In general, large amounts of harmful substances to humans such as carbon monoxide and nitrogen oxides are contained in exhaust gases emitted from a vehicle engine. Strict regulations are being enforced on nitrogen oxides because the nitrogen oxides are particularly harmful in that they contribute to acid rain, global warming, and respiratory problems.

The nitrogen oxides have the property such that, as the combustion temperature of fuel in the engine increases, so does the amount of nitrogen oxides. Many attempts have been made to reduce nitrogen oxide emissions, among which an exhaust gas recirculation (EGR) system is usually applied to vehicles.

The EGR system recirculates part of the exhaust gas emitted from the engine after fuel combustion to an intake system of the engine to direct it back to a combustion chamber of the engine. As a consequence, an air-fuel mixture decreases in density without a change in the air-fuel ratio of then air-fuel mixture, thus lowering the combustion temperature.

That is, the EGR system supplies part of exhaust gas to an intake manifold of the engine to direct it to the combustion chamber when there is a need to reduce nitrogen oxide emissions depending on the operating state of the engine. By doing so, exhaust gases, which are insert gases whose volume does not change, contribute to decrease the density of the mixture to a lower level and therefore decrease the flame propagation velocity during fuel combustion. This suppresses an increase in combustion temperature and slows the fuel combustion, thereby suppressing the generation of nitrogen oxides.

The conventional EGR system described above includes an EGR valve device which is mounted between an exhaust passage of the engine and an EGR cooler, and supplies the exhaust gas emitted from the engine to the exhaust passage to the EGR cooler.

The EGR valve device includes an actuator whose operation is controlled by an electronic control unit, an operating rod which transfers operating force of the actuator, and a flap valve which is rotated by the operating rod and opens and closes a port connected to the EGR cooler.

The flap valve is mounted on a valve housing to be rotatable on a valve shaft, and the valve shaft is connected to the operating rod via a lever. The valve shaft is integrally attached to the lever, usually by metal inert gas (MIG) welding, and connected to the flap valve by MIG welding and riveting so as to rotate integrally with the flap valve.

Regarding the conventional structure for connecting the valve shaft to the lever and the flap valve by MIG welding and riveting, there is a demand for a method of properly preventing reductions in strength and durability due to welding.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide an exhaust gas recirculation valve device for a vehicle having the advantage of improving the strength and durability of welded parts by integrally coupling a valve shaft for rotatably supporting a flap valve to a lever and a flap valve by electron beam welding.

Various aspects of the present invention provide an exhaust gas recirculation valve device for a vehicle, which may include a valve housing having an exhaust gas inlet port and an exhaust gas outlet port, a flap valve rotatably mounted on the valve housing to open and close the exhaust gas outlet port, and a valve shaft fitted to penetrate the flap valve and coupled to the flap valve by electron beam welding to rotate integrally with the flap valve.

One end of the valve shaft may be fitted to penetrate a lever and coupled to the lever by electron beam welding, and the lever may be connected to an actuator through an operating rod.

The exhaust gas inlet port may be connected to or in fluid communication with an exhaust passage, and the exhaust gas outlet port may be connected to or in fluid communication with an EGR cooler.

The valve shaft and the flap valve may be welded together to a length of approximately 20 to 40 mm. The valve shaft and the lever may be welded together to a depth of approximately 2 to 4 mm.

The valve shaft may be made of a material comprising INCONEL 751. The valve shaft may be coated with a CrN coating having a thickness of approximately 10 μm.

Bushes may be fitted and mounted on the outer periphery of the valve shaft, above and below the portion where the flap valve is mounted, and the bushes may be made of a material comprising T400 alloy.

With an exhaust gas recirculation valve device of the present invention, reductions in durability and strength due to welding heat can be minimized during a welding operation, since a valve shaft assembled to penetrate a flap valve is coupled by electron beam welding to the flap valve to rotate together with the flap valve, and the valve shaft is also coupled by electron beam welding to a lever for rotating the valve shaft upon receipt of operating force from an actuator.

As the valve shaft, the lever, and the flap valve are firmly connected together by electron beam welding, connection strength is increased, and the valve shaft and the flap valve do not need to be riveted. Accordingly, productivity improvement and cost reduction can be achieved because of a fewer number process steps employed, and high-temperature strength and wear resistance can be enhanced owing to the high-strength material of the valve shaft.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of an exemplary exhaust gas recirculation valve device for a vehicle according to the present invention.

FIG. 2 is a cross-sectional view showing that a valve shaft of an exemplary exhaust gas recirculation valve device is coupled to a lever and a flap valve according to the present invention.

FIG. 3 is a cross-sectional view showing that the valve shaft of an exemplary exhaust gas recirculation device is coupled to the lever according to the present invention.

FIG. 4 is a cross-sectional view showing that the valve shaft of an exemplary exhaust gas recirculation device is coupled to the flap valve according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

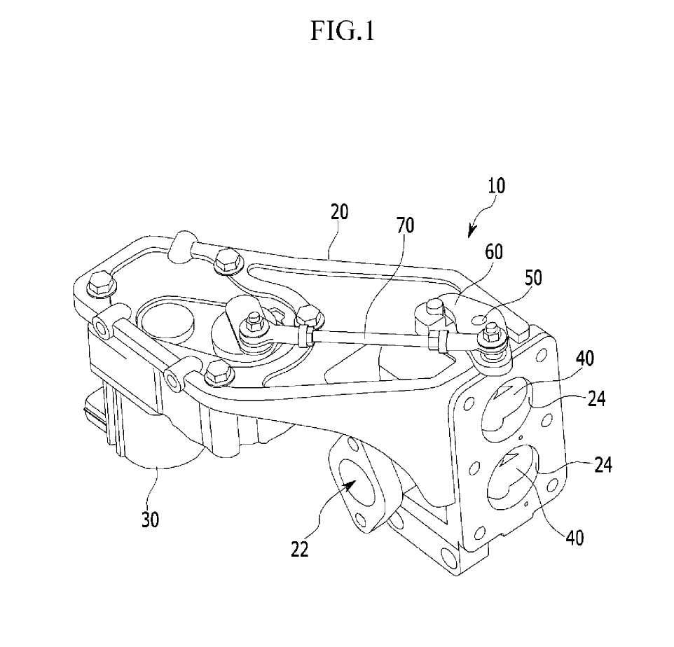

Referring to FIG. 1, an exhaust gas recirculation valve device 10 according to various embodiments of the present invention includes a valve housing 20 and an actuator 30 mounted at a bottom side of the valve housing 20.

In the valve housing 20, an exhaust gas inlet port 22 to be connected to or in fluid communication with an exhaust passage is provided on the opposite side of the portion where the actuator 30 is mounted, and two exhaust gas outlet ports 24 are provided at portions rotated approximately or substantially 90 degrees counterclockwise from the exhaust gas inlet port 22.

The two exhaust gas outlet ports 24 are connected to or in fluid communication with an EGR cooler. The number of the exhaust gas outlet ports 24 does not have to be necessarily two, but may be one or more.

Exhaust gas emitted from the engine after combustion is directed into the valve housing 20 via the exhaust gas inlet port 22 through the exhaust passage, then passes through the two exhaust gas outlet ports 24 and is directed into the EGR cooler. Then, the exhaust gas is properly cooled in the EGR cooler, and then directed back to the engine through an intake device, thereby achieving recirculation.

A flap valve 40 is rotatably installed within the valve housing 20 to open and close the exhaust gas outlet ports 24. The flap valve 40 is coupled to a valve shaft 50 to rotate together with the valve shaft 50, one end of the valve shaft 50 is fitted to penetrate a lever 60 and integrally connected to the lever 60, and an operating rod 70 is communicatively connected to a portion of the lever 60. The operating rod 70 is connected to the actuator 30 so as to receive operating force from the actuator 30.

Accordingly, when the actuator is put into operation upon receipt of an operation control signal from a controller, the operating rod 70 is rotated by the actuator 30, and the rotating motion of the operating rod 70 is directly transferred to the lever 60, thereby causing the lever 60 to rotate.

The valve shaft 50 rotates in synchronization with the rotating motion of the lever 60, and the flap valve 40 also rotates together with the rotating motion of the valve shaft 50 to thereby open and close the exhaust gas outlet ports 24.

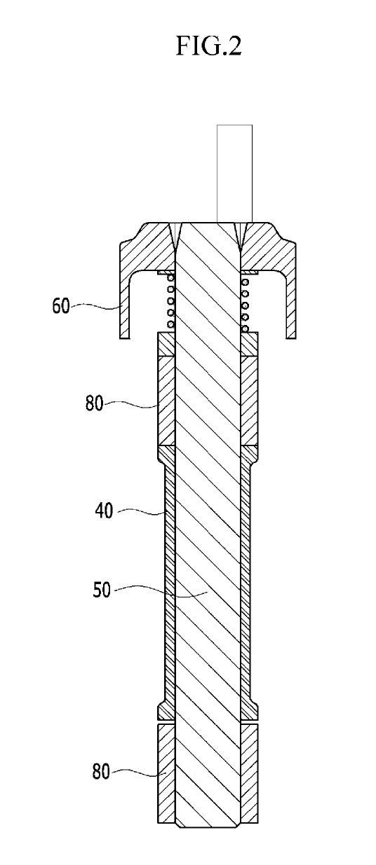

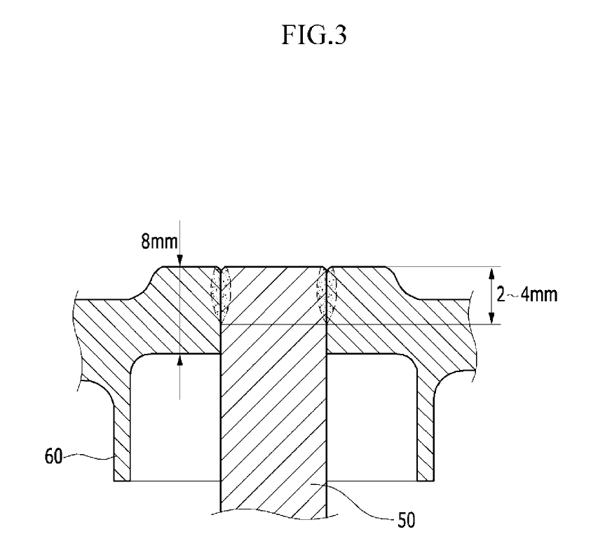

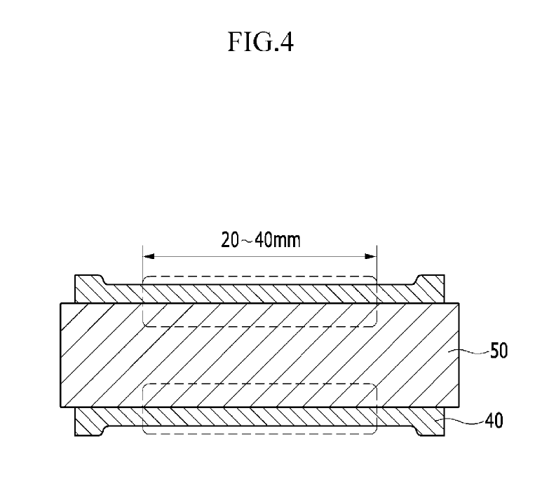

Referring to FIG. 2 to FIG. 4, a through assembly hole is formed in the lever 60, and one end of the valve shaft 50 is fitted into the through assembly hole to integrally couple the lever 60 and the valve shaft 50 together by electron beam welding.

As known in the art, electron beam welding involves radiating an electron beam, focused at high density and accelerated, to a welding object at high speed under vacuum atmosphere. As electrons of the radiated electron beam collide with the welding object, the kinetic energy of the electrons is converted into heat energy and locally generates high-temperature heat, and a welding surface is heated and melted with the thus-generated high-temperature heat, thus enabling bonding of the welding object.

As an example, if the lever 60 is approximately 8 mm thick, the lever 60 is welded from the top to a depth of approximately 2 to 4 mm along the axial direction of the valve shaft 50. The valve shaft 50 is fitted to penetrate the flap valve 40, and integrally coupled to the flap valve 40 by electron beam welding. The welding length of the valve shaft 50 and the flap valve 40 is approximately 20 to 40 mm.

By coupling the valve shaft 50, the lever 60, and the flap valve 40 together, as described above, by electron beam welding, effects from welding heat can be minimized, and therefore strength and durability can be improved.

In various embodiments, the valve shaft 50 is made of a material comprising nickel-chromium super heat resistant alloy such as INCONEL 751, and coated with a CrN coating having a thickness of approximately 10 μm.

Bushes 80 are fitted and mounted on the outer periphery of the valve shaft 50, above and below the portion where the flap valve 40 is mounted. The bushes 80 may be used to rotatably assemble the valve shaft 50 and the flap valve 40 to the valve housing 20. In various embodiments, the bushes 80 are made of a material comprising T400 alloy.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An exhaust gas recirculation valve device for a vehicle, comprising:
a valve housing having an exhaust gas inlet port and an exhaust gas outlet port;
a flap valve rotatably mounted on the valve housing to open and close the exhaust gas outlet port; and
a valve shaft fitted to penetrate the flap valve and coupled to the flap valve by electron beam welding to rotate integrally with the flap valve.

2. The exhaust gas recirculation valve device of claim 1, wherein
one end of the valve shaft is fitted to penetrate a lever and coupled to the lever by electron beam welding, and
the lever is connected to an actuator through an operating rod.

3. The exhaust gas recirculation valve device of claim 1, wherein
the exhaust gas inlet port is in fluid communication with an exhaust passage, and
the exhaust gas outlet port is in fluid communication with an EGR cooler.

4. The exhaust gas recirculation valve device of claim 1, wherein the valve shaft and the flap valve are welded together to a length of approximately 20 to 40 mm.

5. The exhaust gas recirculation valve device of claim 2, wherein the valve shaft and the lever are welded together to a depth of approximately 2 to 4 mm.

6. The exhaust gas recirculation valve device of claim 1, wherein the valve shaft is made of a material comprising INCONEL 751.

7. The exhaust gas recirculation valve device of claim 6, wherein the valve shaft is coated with a CrN coating having a thickness of approximately 10 μm.

8. The exhaust gas recirculation valve device of claim 1, wherein bushes are fitted and mounted on an outer periphery of the valve shaft, above and below a portion where the flap valve is mounted, and the bushes are made of a material comprising T400 alloy.
